(19) United States
(12) Patent Application Publication
(10) Pub. No.: US 2018/0239329 A1
(43) Pub. Date: Aug. 23, 2018

(54) ADAPTIVE LUBRICATION CONTROL DEVICE AND METHOD FOR AXIAL SYSTEM OF MACHINING CENTER

(71) Applicant: YEONG CHIN MACHINERY INDUSTRIES CO., LTD., Taichung City (TW)

(72) Inventors: Min-Sin Liou, Taichung City (TW); Kuo-Liang Huang, Taichung City (TW); Wan-Ting Chiu, Taoyuan City (TW)

(21) Appl. No.: 15/437,461

(22) Filed: Feb. 21, 2017

(51) Int. Cl. G05B 19/27; B23Q 11/12; F16N 19/00

(52) U.S. Cl. CPC G05B 19/27; G05B 2219/2618; F16N 19/00; B23Q 11/124

(57) ABSTRACT

An adaptive lubrication control method used in an adaptive lubrication control system for a machining center having an axial system comprises a controller and a lubricating system. The method uses a built-in macro program unit and programmable logic unit of the controller to acquire the feed rate and load data of the axial system of the machining center for computing the shift parameter of the axial system so that the optimal lubrication timing and lubrication time length can be figured out for controlling the lubricating system to lubricate the axial system automatically.

### BACKGROUND OF THE INVENTION

### (a) Field of the Invention

The present invention relates to motorcycle technology and more particularly to an adaptive lubrication control system and method for axial system of machining center, which uses the built-in macro program unit and programmable logic unit of the controller to acquire the feed rate and load data of the axial system of the machining center for computing the shift parameter of the axial system so that the optimal lubrication timing and lubrication time length can be figured out for controlling the lubricating system to lubricate the axial system automatically.

### (b) Description of the Prior Art

Properly lubricating the axial system (feed system) of a machining center can reduce frictional resistance between the driving mechanism and the guide rail and work platform, avoiding temperature rise and frictional wear during climbing at a low speed and maintaining the service life of the axial system. Therefore, lubrication will be implemented during the operation of the axial system.

In recent years, machining center maintenance-related knowledge and technology has been advancing. When buying a machining center, many users will select the model with an automatic lubricating system. However, conventional machining center axial system lubricating techniques commonly adopt the method of timed automatic lubrication. When the machining center undergoes machining, the controller of the machining center obtains a moving signal from the axial system and a programmable logic unit of the controller controls the implementation of a lubrication operation for a predetermined length of time and then stops the lubrication. The lubrication procedure is cycled in this manner. Therefore, the conventional lubrication control technology is to implement lubrication according to the predetermined procedure and cycle frequency, regardless of the factors of feed rate, load, moving time and moving distance of the axial system.

However, in the implementation of the conventional lubrication control technology, an excessive amount of the lubricating grease will be applied to the axial system if the axial system is being moved at a low speed during the machining operation, leading to a lubricating grease overflow of the lubricating grease reservoir of the axial system and increasing lubricating grease consumption. On the contrary, if the axial system is being moved at a high speed during the machining operation, there may be insufficient lubrication, resulting in frictional wear or viscous drag of the axial rail of the axial system. All these conditions will shorten the service life of the axial system.

### SUMMARY OF THE INVENTION

The present invention has been accomplished under the circumstances in view. It is one object of the present invention to provide an adaptive lubrication control system and method, which automatically lubricates the axial system of the machining center according to actual needs, thus alleviating the over lubrication and insufficient lubrication problems of the conventional techniques.

To achieve this and other objects of the present invention, an adaptive lubrication control system for axial system of a machining center comprises a controller and a lubricating system mounted in the machining center. The axial system is mounted in a feed system of the machining center for feeding a workpiece to a tool of the machining center for processing. The controller has built therein a programmable logic unit and a macro program unit. The programmable logic unit is adapted to detect the feed rate and load of the axial system, and to provide the detected feed rate and load data to the macro program unit. Further, the programmable logic unit is capable of instructing the lubricating system to perform lubrication. The macro program unit is adapted for acquiring the feed rate and load data of the axial system, computing the feed rate and load data to obtain the shift parameter of the axial system, determining the lubrication timing and lubrication time length of the lubrication performance of the lubricating system according to the shift parameter thus obtained, and providing the message of the determined lubrication timing and lubrication time length to the programmable logic unit for enabling the programmable logic unit to give a command to the lubricating system. The lubricating system comprises a lubricating grease storage unit storing a lubricating grease, a lubricating grease withdrawing unit connected to the lubricating grease storage unit for withdrawing the lubricating grease from the lubricating grease storage unit toward the axial system, and a pipeline connecting the lubricating grease withdrawing unit to the axial system for delivering the lubricating grease from the lubricating grease storage unit to the axial system for lubrication.

To achieve this and other objects of the present invention, an adaptive lubrication control is applied to the aforesaid adaptive lubrication control system, comprising the steps of: (a) processing: enabling the linear drive unit and the slide unit of said axial system to start a moving action when the machining center is undergoing machining; (b) axial system feed rate and load acquisition: enabling the programmable logic unit of the controller to detect the operating status of the machining center periodically so that the macro program unit is enabled to acquire the feed rate and load data of the axial system; (c) axial system shift parameter computation: enabling the macro program unit to compute the acquired feed rate and load data so as to obtain the shift parameter of the axial system; (d) lubrication timing determination: enabling the macro program unit to determine the lubrication timing and lubrication time length of the lubricating system according to the shift parameter thus obtained; and (e) axial system lubrication implementation: enabling the macro program unit to provide the message of the determination of the lubrication timing and lubrication time length to the programmable logic unit so that the programmable logic unit is enabled to instruct the lubricating system to lubricate the axial system.

The adaptive lubrication control system and method for axial system of machining center can control the lubricating system to lubricate the linear drive unit and slide unit of the axial system according to the shift parameter of the axial system. By means of using the feed rate and load data of the axial system of the machining center to compute the shift parameter of the axial system, the macro program unit can figure out the optimal lubrication timing and lubrication time length for controlling the lubricating system to lubricate the axial system automatically, thus alleviating the over lubrication and insufficient lubrication problems of the conventional techniques.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a block diagram of an adaptive lubrication control system in accordance with the present invention as used for an axial system of a machining center.

FIG. 2 is a detailed block diagram of the adaptive lubrication control system in accordance with the present invention as used for an axial system of a machining center.

FIG. 3 is a flow chart of an adaptive lubrication control method in accordance with the present invention.

### DETAILED DESCRIPTION OF THE PREFERRED EMBODIMENTS

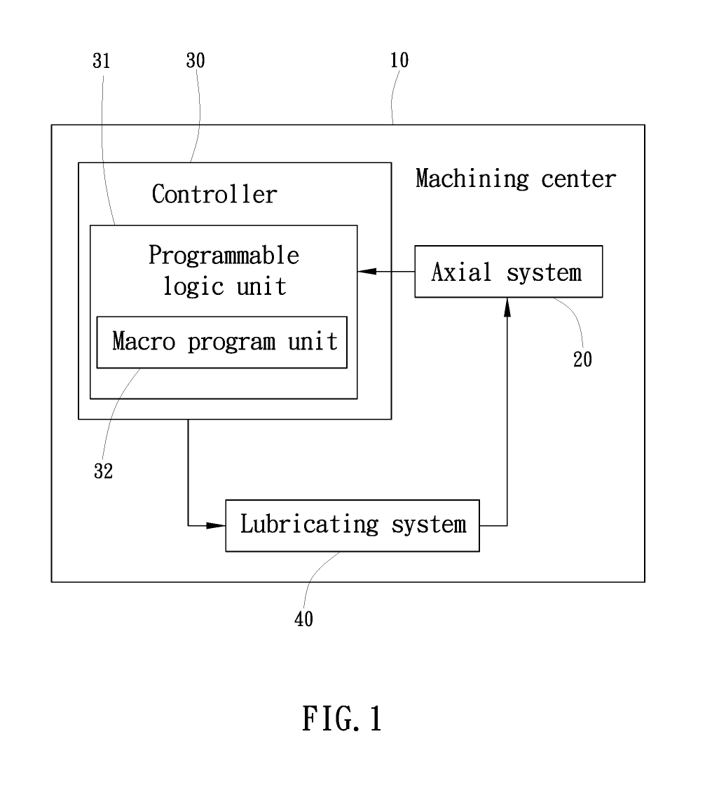

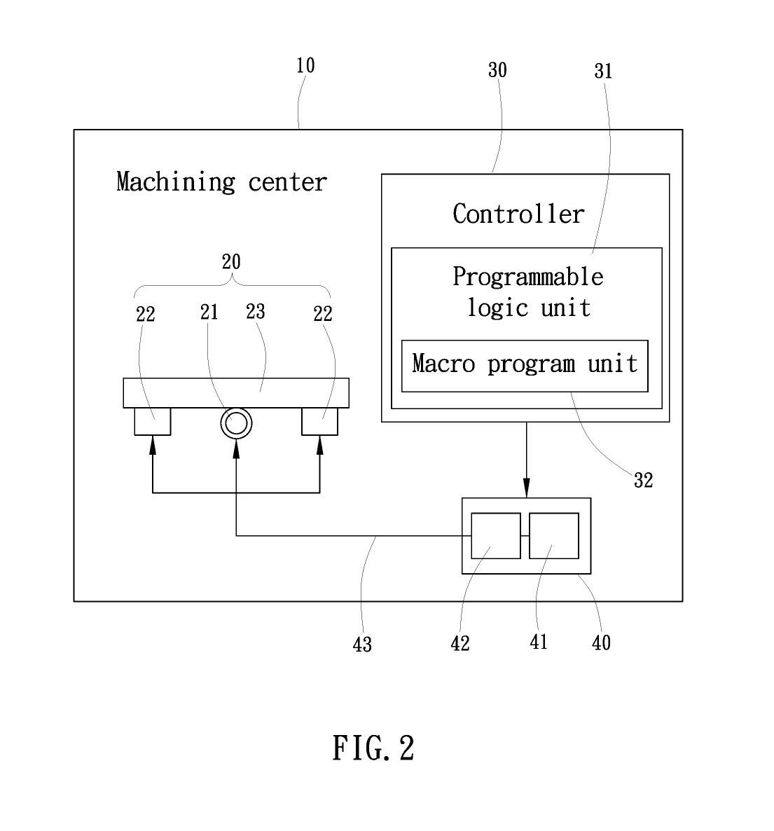

The invention provides an adaptive lubrication control system and method for axial system of machining center that is adapted to acquire the operation data of the axial system of a machining center for statistical analysis so as to further provide the machining center with a sufficiently reliable diagnosis and then to adaptively control the lubrication of the axial system. As illustrated in FIGS. 1 and 2, the adaptive lubrication control system for axial system 20 of a machining center 10 generally comprises a controller 30 and a lubricating system 40 respectively mounted in the machining center 10.

The machining center 10 can be a vertical machining center, horizontal machining center, gantry type machining center or 5-axis machining center.

The axial system 20 is installed in the feed system of the machining center 10 for feeding the workpiece to the tool for processing. In the preferred embodiment of the present invention, the axial system 20 comprises a linear drive unit 21 for performing a feeding operation, a slide unit 22, and a work platform 23. The slide unit 22 is drivable by the linear drive unit 21 to move the work platform 23 alternatively forwards and backwards, thereby performing feed and return actions.

The controller 30 is a programmable logic controller, having built therein a programmable logic unit 31 and a macro program unit 32. The programmable logic unit 31 can detect the feed rate and load of the axial system 20 and then transmit the detected feed rate and load data to the macro program unit 32. The programmable logic unit 31 can also instruct the lubricating system 40 to perform lubrication. The macro program unit 32 is a pre-written program stored in the programmable logic unit 31 adapted for acquiring the feed rate and load data of the axial system 20, computing the acquired feed rate and load data of obtain the shift parameter of the axial system 20, determining the lubrication timing and the lubrication time length of the lubricating system 40 according to the shift parameter, and providing the determination message to the programmable logic unit 32 so that the programmable logic unit 32 can give a command to the lubricating system 40.

The lubricating system 40 in the present preferred embodiment comprises a lubricating grease storage unit 41 for storing a lubricating grease, a lubricating grease withdrawing unit 42 connected to the lubricating grease storage unit 41, and a pipeline 43 connecting the lubricating grease withdrawing unit 42 to the linear drive unit 21 and slide unit 22 of the axial system 20. Thus, the controller 30 can automatically control the lubricating grease withdrawing unit 42 to withdraw the storage lubricating grease from the lubricating grease storage unit 41 through the pipeline 43 to the linear drive unit 21 and slide unit 22 of the axial system 20 for lubrication.

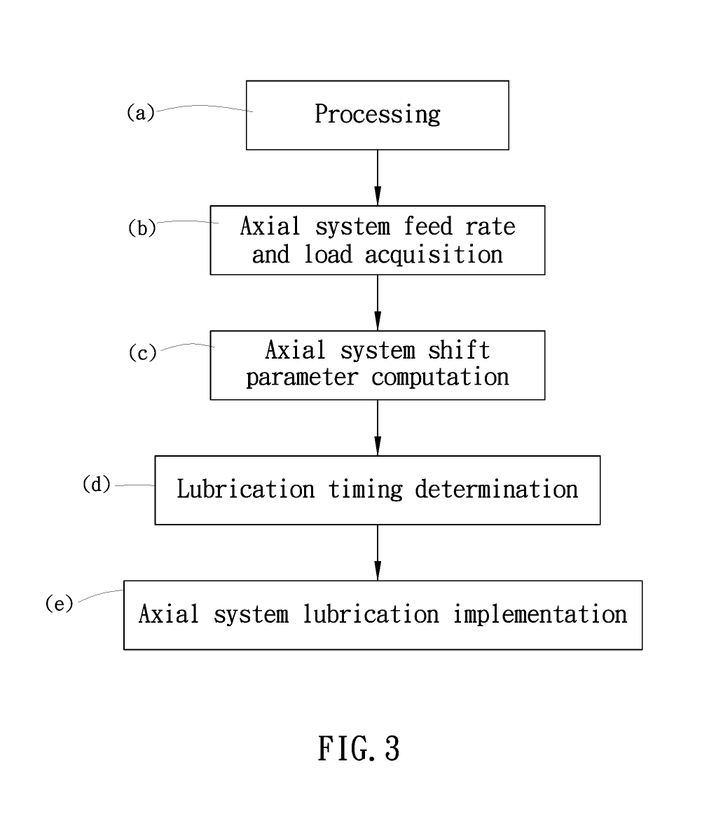

Referring to FIG. 3, an adaptive lubrication control method is used in the aforesaid adaptive lubrication control system, comprising the steps of:

(a) Processing: Enable the linear drive unit 21 and slide unit 22 of the axial system 20 to start a moving action when the machining center 10 is undergoing machining.

(b) Axial system feed rate and load acquisition: Enable the controller 30 to acquire the data of the feed rate and load of the axial system 20 periodically. In this step, the programmable logic unit 31 detects the operating status of the machining center 10, enabling the macro program unit 32 to acquire the feed rate and load data of the axial system 20.

(c) Axial system shift parameter computation: Enable the macro program unit 32 to compute the acquired feed rate and load data so as to obtain the shift parameter of the axial system 20.

(d) Lubrication timing determination: Enable the macro program unit 32 to determine the lubrication timing and lubrication time length of the lubricating system 40 according to the shift parameter thus obtained.

(e) Axial system lubrication implementation: Enable the macro program unit 32 to provide the message of the determination of the lubrication timing and lubrication time length to the programmable logic unit 31 so that the programmable logic unit 31 is enabled to instruct the lubricating system 40 to lubricate the axial system 20.

The adaptive lubrication control system and method for axial system of machining center can control the lubricating system 40 to lubricate the linear drive unit 21 and slide unit 22 of the axial system 20 according to the shift parameter of the axial system 20. By means of using the feed rate and load data of the axial system of the machining center to compute the shift parameter of the axial system, the macro program unit 32 can figure out the optimal lubrication timing and lubrication time length for controlling the lubricating system to lubricate the axial system automatically, alleviating the over lubrication and insufficient lubrication problems of the conventional techniques.

What is claimed is:

1. An adaptive lubrication control system for a machining center having an axial system for feeding a workpiece to a tool of said machining center for processing, said adaptive lubricating control system comprising a controller and a lubricating system mounted in said machining center, wherein:
said controller has built therein a programmable logic unit and a macro program unit, said programmable logic unit being adapted to detect the feed rate and load of said axial system and to provide the detected feed rate and load data to said macro program unit and capable of instructing said lubricating system to perform lubrication, said macro program unit being adapted for acquiring from said programmable logic unit the said feed rate and load data of said axial system, computing the said feed rate and load data to obtain a shift parameter of said axial system, determining lubrication timing and lubrication time length of lubrication performance of said lubricating system according to the said shift parameter thus obtained and then providing the determined lubrication timing and lubrication time length to said programmable logic unit for enabling said programmable logic unit to give a command to said lubricating system; and
said lubricating system is controllable by said controller to lubricate said axial system.

2. The adaptive lubrication control system as claimed in claim 1, wherein said axial system comprises a linear drive unit and a slide unit adapted for carrying a work platform.

3. The adaptive lubrication control system as claimed in claim 1, wherein said lubricating system comprises a lubricating grease storage unit storing a lubricating grease, a lubricating grease withdrawing unit connected to said lubricating grease storage unit for withdrawing said lubricating grease from said lubricating grease storage unit toward said axial system, and a pipeline connecting said lubricating grease withdrawing unit to said axial system for delivering said lubricating grease from said lubricating grease storage unit to said axial system for lubrication.

4. An adaptive lubrication control method for the adaptive lubrication control system as claimed in claim 1, comprising the steps of:
(a) processing: enabling said linear drive unit and said slide unit of said axial system to start a moving action when said machining center is undergoing machining;
(b) axial system feed rate and load acquisition: enabling said programmable logic unit of said controller to detect the operating status of said machining center periodically so that said macro program unit is enabled to acquire from said programmable logic unit the feed rate and load data of said axial system;
(c) axial system shift parameter computation: enabling said macro program unit to compute the acquired said feed rate and load data so as to obtain a shift parameter of said axial system;
(d) lubrication timing determination: enabling said macro program unit to determine lubrication timing and lubrication time length of said lubricating system according to the said shift parameter thus obtained; and
(e) axial system lubrication implementation: enabling said macro program unit to provide the determined lubrication timing and lubrication time length to said programmable logic unit so that said programmable logic unit is enabled to instruct said lubricating system to lubricate said axial system.
